(19) United States
(12) Patent Application Publication
(10) Pub. No.: US 2020/0169097 A1
(43) Pub. Date: May 28, 2020

(54) MODULARIZATION SYSTEM AND METHOD FOR BATTERY EQUALIZERS BASED ON MULTI- WINDING TRANSFORMERS

(71) Applicant: SHANDONG UNIVERSITY, Jinan, Shandong (CN)

(72) Inventors: Chenghui ZHANG, Jinan (CN); Yunlong SHANG, Jinan (CN); Qi ZHANG, Jinan (CN); Naxin CUI, Jinan (CN); Bin DUAN, Jinan (CN)

(73) Assignee: SHANDONG UNIVERSITY, Jinan, Shandong (CN)

(21) Appl. No.: 16/492,836

(22) PCT Filed: Oct. 19, 2017
(86) PCT No.: PCT/CN2017/106903

§ 371 Date: Sep. 10, 2019

(30) Foreign Application Priority Data
Mar. 16, 2017 (CN) 201710157515.6

(51) Int. Cl. H02J 7/00

(52) U.S. Cl. CPC H02J 7/0014

(57) ABSTRACT

A modularization system and a method for battery equalizers based on multi-winding transformers. By the inverse-parallel connection of the secondary sides of the odd and the even multi-winding transformers, the balancing in battery modules and between the odd and the even groups is realized based on forward conversion, and the balancing between the odd and the even groups and the automatic demagnetization for the transformers are realized based on flyback conversion. By only using a pair of complementary control signals, the direct, automatic and simultaneous balancing from any battery cell to any battery cell in the battery strings can be realized, thereby greatly improving the balancing efficiency and speed, and effectively improving the consistencies between the battery cells. The system has the advantages of high balancing efficiency, fast balancing speed, small size, low cost, high reliability, easy modularization, simple control, and nonuse of voltage detection circuits and demagnetizing circuits, etc.

### FIELD OF THE INVENTION

The present invention relates to a modularization system and a method for battery equalizers based on multi-winding transformers.

### BACKGROUND OF THE INVENTION

Lithium-ion batteries have been widely used in electric vehicles because of their advantages of no memory effect, high energy density, high cell voltage, good safety, etc. In order to meet the voltage and power levels of electric vehicles, a large number of lithium-ion battery cells need to be used in series and parallel. However, due to the manufacturing tolerance and the difference of working environments, the internal resistances and capacities of the battery cells are not completely consistent. During the use of the battery strings, these inconsistencies may gradually accumulate and cause the voltage imbalance of series-connected battery cells. Because batteries cannot be over charged or over discharged, the cell voltage imbalance will significantly reduce the available capacity and cycle life of battery strings. Therefore, battery equalizers are required to compensate the inconsistency among battery cell voltages.

Currently, many active equalizers are developed to transfer energy from higher voltage battery cells to lower voltage battery cells based on capacitors, inductors or transformers. Among these methods, the transformer-based balancing method has the advantages of good isolation performance, high efficiency, simple control, fast balancing speed, etc.

For example, Chinese invention patent (application No. 201210144266.4) proposed a battery equalizer using a symmetric multi-winding transformer based on forward conversion. The balancing circuit can realize the automatic energy transfer from the higher-voltage battery cells to the lower-voltage battery cells by only using one control signal, and has the advantages of simple control and high balancing efficiency, etc. However, this solution requires an additional demagnetizing circuit (a resonant LC circuit composed of a capacitor and an magnetic inductance) to absorb and release the energy stored in the transformer when the switches are turned off. This results in transformer winding inconsistency, high circuit cost, bulk size, complex design, etc. It is worth mentioning that the mismatched multi windings will lead to a natural imbalance among cell voltages. Moreover, in order to obtain soft switching, the balancing circuit can only work at a specific switching frequency and duty cycle, leading to a complicated design and control. Particularly, the modularization of the balancing circuit is difficult to realize.

### SUMMARY OF THE INVENTION

In order to solve the above problems, the present invention discloses a modularization system and a method for battery equalizers based on multi-winding transformers.

First, the present invention discloses a modularization system for battery equalizers based on multi-winding transformers, which realizes, by inverse-parallelly connecting the secondary sides of the odd and the even multi-winding transformers, the balancing in battery modules and between the odd and the even modules based on forward conversion, the balancing between the odd and the even groups and the automatic demagnetization for the transformers based on flyback conversion.

Second, the present invention discloses a modularization method for battery equalizers based on multi-winding transformers, which can realize the direct, automatic and simultaneous balancing from any battery cell to any battery cell in the battery strings by only using a pair of complementary control signals. The present invention greatly improves the balancing efficiency and speed, and the consistency of the battery cells. The present invention has the advantages of high balancing efficiency, fast balancing speed, small size, low cost, high reliability, easy modularization, simple control, nonuse of voltage detection circuits, etc.

In order to achieve the above objectives, the present invention adopts the following technical solution:

A modularization system for battery equalizers based on multi-winding transformers, includes a plurality of battery modules, a microcontroller, a plurality of multi-winding transformers, and a plurality of MOS transistors, wherein each battery module includes a plurality of battery cells, and each battery module is correspondingly configured with a multi-winding transformer;

The multi-winding transformer includes y primary windings and a secondary winding. Each battery cell is connected to the drain of an MOS transistor, and the source of the MOS transistor is connected to one terminal of a primary winding of a multi-winding transformer. The other terminal of the primary winding is connected to the cathode of the battery cell to form a current loop, and the microcontroller outputs two paths of complementary PWM signals to respectively drive the MOS transistors for the primary windings having opposite dotted terminals.

Further, x*y battery cells are provided, wherein x is the number of battery modules, and y is the number of battery cells included in one battery module.

Further, the secondary sides of the adjacent multi-winding transformers are connected in reverse-parallel.

Further, the secondary windings of the multi-winding transformers are connected in parallel.

The multi-winding transformers are divided into two groups, and the secondary windings of the odd and the even transformers have opposite dotted terminals.

Further, the PWM signal output terminals send a pair of complementary high-frequency PWM signals, namely PWM+ and PWM−;

The PWM+ signal is connected to the gates of the MOS transistors for the primary windings of the odd transformer through a driving circuit to generate the control driving signal for turn-ON and turn-OFF of the MOS transistors in the odd battery group;

The PWM− signal is connected to the gates of the MOS transistors for the primary windings of the even transformer through a driving circuit to generate the control driving signal for turn-ON and turn-OFF of the MOS transistors in the even battery group.

A modularization method for battery equalizers based on multi-winding transformers is provided. The PWM signal output terminals of a microcontroller send a pair of complementary PWM signals to respectively control the alternate turn-ON of the MOS transistors for the odd and the even multi-winding transformers. The balancing in battery modules and between the odd and the even groups is realized based on forward conversion, and the balancing between the odd and the even groups and the automatic demagnetization for the transformers are realized based on flyback conversion.

Further, the control method includes four operation modes:

(1) When the MOS transistors of the odd transformers are turned ON, the demagnetization of the even transformers are automatically realized based on flyback conversion, the balancing between the odd and the even groups is realized, and the balancing in the odd groups and between the battery modules is realized based on forward conversion;

(2) The MOS transistors of the odd transformers remain ON, the balancing in the odd groups and between the battery modules is realized based on forward conversion, and a precondition is provided for demagnetization of the odd transformers;

(3) The MOS transistors of the even transformers are turned ON, the demagnetization of the odd transformers are automatically realized based on flyback conversion, the balancing between the odd and the even groups is realized, and the balancing in the even groups and between the battery modules is realized based on forward conversion; and

(4) The MOS transistors of the even transformers remain ON, and the balancing in the even groups and between the battery modules is realized based on forward conversion.

Further, after the continual alternation of the four modes, the balancing in the battery modules and between the odd and the even groups is realized based on forward conversion; and the balancing between the odd and the even groups is realized based on flyback conversion, thereby achieving the global balancing of the whole battery strings, and automatically demagnetizing all the transformers.

The control method is applied to the charging, discharging or stationary state of the battery strings.

Compared with the prior art, the present invention has the beneficial effects:

(1) The present invention can realize the direct balancing from any battery cell to any battery cell in the battery strings, greatly improve the balancing efficiency and the balancing speed, and can operate in the charging, discharging or stationary state of the battery strings;

(2) Automatic balancing can be achieved without voltage detection circuits, thereby reducing the circuit size, and reducing the use cost; only one MOS transistor is needed for one battery cell, which greatly reduces the circuit size;

(3) The balancing circuit proposed by the present invention is easy to modularize, and the balancing between the battery modules can be realized only by parallelly connecting the secondary windings of the plurality of multi-winding transformers without the need of other outside balancing circuits, thereby reducing the circuit size;

(4) The balancing circuit is controlled by only a pair of complementary PWM signals to alternately operate in two states, so the control is simple and the reliability is high; the transformers are automatically demagnetized by the complementary structure and control of the odd and the even multi-winding transformers, which greatly reduces the voltage stress on switches and improves the reliability of the circuit; additional demagnetizing circuits are not required, so the circuit size is further reduced;

(5) The system and the method can be implemented widely, and are applicable to lithium-ion, nickel-metal hydride, lead-acid and other rechargeable power batteries, without changing the parameters of the devices in the circuit.

### BRIEF DESCRIPTION OF THE DRAWINGS

The accompanying drawings constituting a part of the present application are used for providing a further understanding of the present application, and the schematic embodiments of the present application and the descriptions thereof are used for interpreting the present application, rather than constituting improper limitations to the present application.

FIG. 1 is a schematic diagram of the balancing circuit applied to x*y battery strings according to the present invention;

FIG. 2 is a schematic diagram of the balancing circuit applied to 2*4 battery strings according to the present invention;

FIG. 3(a)-FIG. 3(d) are operation modes of the modularized balancing circuit according to the present invention;

FIG. 4 is a key waveform diagram of the balancing circuit according to the present invention;

FIG. 5 is an efficiency and load relationship diagram of the balancing circuit according to the present invention;

FIG. 6 is an experimental effect diagram of two battery modules and eight battery cells.

### DETAILED DESCRIPTION OF EMBODIMENTS

The present invention will be further illustrated below in conjunction with the accompanying drawings and embodiments.

It should be pointed out that the following detailed descriptions are all exemplary and aim to further illustrate the present application. Unless otherwise specified, all technical and scientific terms used in the descriptions have the same meanings generally understood by those of ordinary skill in the art of the present application.

It should be noted that the terms used herein are merely for describing specific embodiments, but are not intended to limit exemplary embodiments according to the present application. As used herein, unless otherwise explicitly pointed out by the context, the singular form is also intended to include the plural form. In addition, it should also be understood that when the terms “include” and/or “comprise” are used in the specification, they indicate features, steps, operations, devices, components and/or their combination.

A modularization method for battery equalizers based on multi-winding transformers involves x*y battery cells, a microcontroller, a plurality of multi-winding transformers, and x*y MOS transistors.

The multi-winding transformer includes y primary windings and one secondary winding;

One battery cell is connected to the drain of one MOS transistor, the source of the MOS transistor is connected to one terminal of one primary winding of one transformer, and the other terminal of the winding is connected to the cathode of the battery cell, thus forming a current loop;

The secondary windings of the multi-winding transformers are connected in parallel;

The multi-winding transformers are divided into two groups, and the secondary windings of the odd and the even transformers have opposite dotted terminals;

The microcontroller includes two pulse width modulation (PWM) signal output terminals;

The PWM signal output terminals send a pair of complementary high-frequency PWM signals, namely PWM+ and PWM−;

The PWM+ signal is connected to the gates of the MOS transistors for the primary windings of the odd transformer through a driving circuit to generate the control driving signal for turn-ON and turn-OFF of the MOS transistors in the odd battery group;

The PWM− signal is connected to the gates of the MOS transistors for the primary windings of the even transformer through a driving circuit to generate the control driving signal for turn-ON and turn-OFF of the MOS transistors in the even battery group.

A modularization method for battery equalizers based on multi-winding transformers includes the following steps:

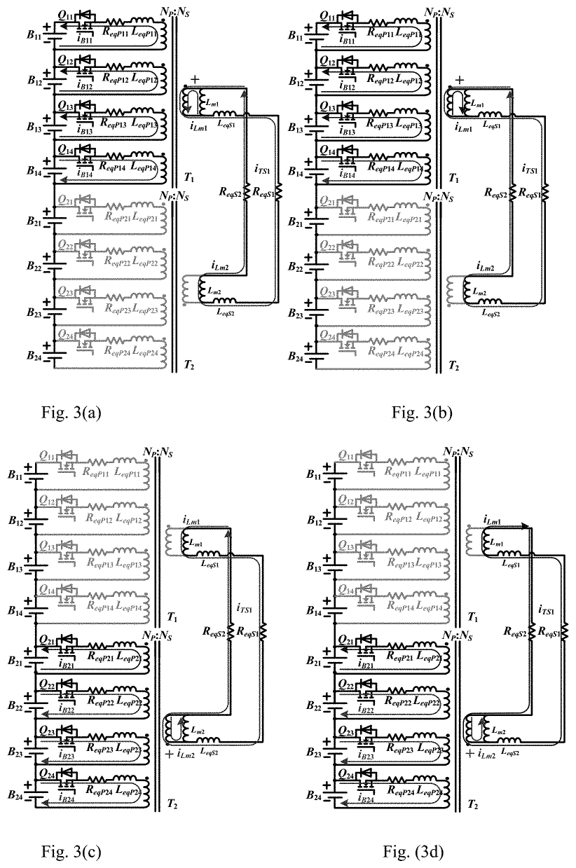

(1) The PWM signal output terminals of the microcontroller send a pair of complementary PWM signals (PWM+ and PWM−) to control alternate turn-ON of the MOS transistors for the odd and the even transformers, including four operation modes, as shown in FIG. 3, that is, four operation states of the present invention.

(2) Mode I: the MOS transistors of the odd transformers are turned ON, the demagnetization of the even transformers are automatically realized based on flyback conversion, the balancing between the odd and the even groups is realized, and the balancing in the odd groups and between the battery modules is realized based on forward conversion.

(3) Mode II: the MOS transistors of the odd transformers remain ON, the balancing in the odd groups and between the battery modules is still realized based on forward conversion, and a precondition is provided for demagnetization of the odd transformers.

(4) Mode III: the MOS transistors of the even transformers are turned ON, the demagnetization of the odd transformers are automatically realized based on flyback conversion, the balancing between the odd and the even groups is realized, and the balancing in the even groups and between the battery modules is realized based on forward conversion.

(5) Mode IV: the MOS transistors of the even transformers remain ON, and the balancing in the even groups and between the battery modules is still realized based on forward conversion.

(6) After the continual alternation of the four modes, the balancing in the battery modules and between the odd and the even groups is realized based on forward conversion. Based on flyback conversion, the balancing between the odd and the even groups is achieved on the one hand, thereby achieving global balancing of the whole battery strings; and all the transformers are automatically demagnetized on the other hand, thereby reducing the voltage stress on switches, eliminating the need for additional demagnetizing circuits and reducing circuit size.

A specific embodiment of the present invention is given below.

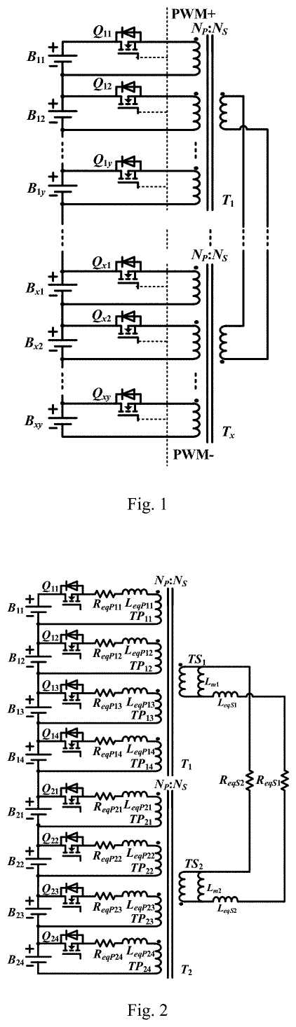

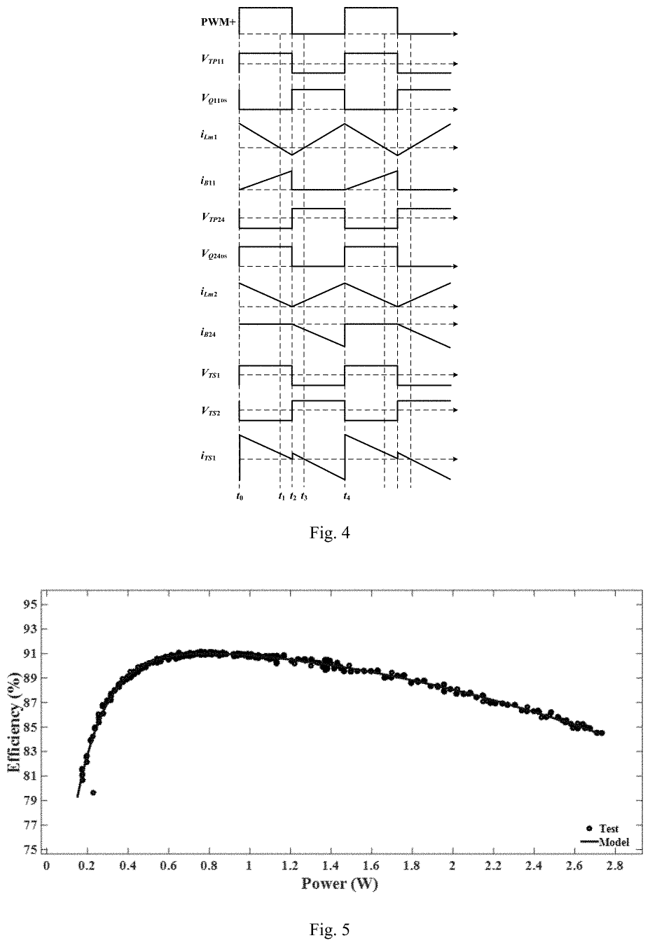

As shown in FIG. 1 to FIG. 5, a modularization method for battery equalizers based on multi-winding transformers involves eight battery cells in two battery modules, a microcontroller, two multi-winding transformers, and eight MOS transistors.

The multi-winding transformer includes four primary windings and one secondary winding;

One battery cell is connected to the drain of one MOS transistor, the source of the MOS transistor is connected to one terminal of one primary winding of one transformer, and the other terminal of the winding is connected to the cathode of the battery cell, thus forming a current loop;

The secondary windings of the multi-winding transformers are connected in parallel;

The multi-winding transformers are divided into two groups, and the secondary windings of the odd and the even transformers have opposite dotted terminals;

The microcontroller includes two PWM signal output terminals;

The PWM signal output ends send a pair of complementary high-frequency PWM signals, namely PWM+ and PWM−;

The PWM+ signal is connected to the gates of the MOS transistors for the primary windings of the odd transformer through a driving circuit to generate the control driving signal for turn-ON and turn-OFF of the MOS transistors in the odd battery group;

The PWM− signal is connected to the gates of the MOS transistors for the primary windings of the even transformer through a driving circuit to generate the control driving signal for turn-ON and turn-OFF of the MOS transistors in the even battery group.

Taking eight battery cells in two battery modules as an example, it is assumed that the voltages of the battery cells satisfy V_{B24}>V_{B23}>V_{B22}>V_{B21}>V_{B14}>V_{B13}>V_{B12}>V_{B11}.

FIG. 5 shows the relationship between the balancing efficiency and the balancing power according to the present invention. It is shown that, the present invention has higher balancing efficiency within a wide load range, and the highest efficiency can reach 89.4%.

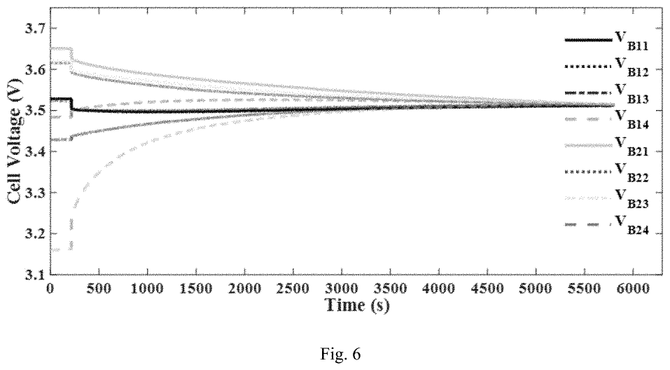

FIG. 6 shows an balancing experiment diagram of the present invention. The initial voltages of the battery cells are respectively 3.528 V, 3.524 V, 3.429 V, 3.165 V, 3.652 V, 3.616 V, 3.621 V, and 3.483 V, and the maximum initial voltage difference is 0.487 V. After 5800 s, the voltages of all the battery cells are simultaneously converged to about 3.515 V, and the maximum voltage difference is 3 mV. The experimental results show that the balancing circuit of the present invention can achieve simultaneous balancing of any battery cell to any battery cell, and have fast balancing speed and high balancing efficiency.

Described above are merely preferred embodiments of the present application, and the present application is not limited thereto. Various modifications and variations may be made to the present application for those skilled in the art. Any modification, equivalent substitution, improvement or the like made within the spirit and principle of the present application shall fall into the protection scope of the present application.

Although the specific embodiments of the present invention are described above in combination with the accompanying drawings, the protection scope of the present invention is not limited thereto. It should be understood by those skilled in the art that various modifications or variations could be made by those skilled in the art based on the technical solution of the present invention without any creative effort, and these modifications or variations shall still fall into the protection scope of the present invention.

1. A modularization system for battery equalizers based on multi-winding transformers, the system comprising a plurality of battery modules, a microcontroller, a plurality of multi-winding transformers, and a plurality of MOS transistors, wherein each battery module comprises a plurality of battery cells, and each battery module is correspondingly configured with a multi-winding transformer;
the multi-winding transformer comprises y primary windings and a secondary winding, each battery cell is connected to the drain of an MOS transistor, and a source of the MOS transistor is connected to one terminal of a primary winding of a multi-winding transformer, the other terminal of the primary winding is connected to the cathode of the battery cell to form a current loop, and the microcontroller outputs two paths of complementary PWM signals to respectively drive the MOS transistors for the primary windings having opposite dotted terminals.

2. The modularization system for battery equalizers based on multi-winding transformers according to claim 1, wherein x*y battery cells are provided, x is the number of battery modules, and y is the number of battery cells included in one battery module.

3. The modularization system for battery equalizers based on multi-winding transformers according to claim 1, wherein the secondary sides of the adjacent multi-winding transformers are connected in reverse-parallel.

4. The modularization system for battery equalizers based on multi-winding transformers according to claim 1, wherein the secondary windings of the multi-winding transformers are connected in parallel.

5. The modularization system for battery equalizers based on multi-winding transformers according to claim 1, wherein the multi-winding transformers are divided into two groups, and the secondary windings of the odd and the even transformers have opposite dotted terminals.

6. The modularization system for battery equalizers based on multi-winding transformers according to claim 5, wherein the PWM signal output terminals send a pair of complementary high-frequency PWM signals, namely PWM+ and PWM−;
the PWM+ signal is connected to the gates of the MOS transistors for the primary windings of the odd transformer through a driving circuit to generate the control driving signal for turn-ON and turn-OFF of the MOS transistors in the odd battery group; and
the PWM− signal is connected to the gates of the MOS transistors for the primary windings of the even transformer through a driving circuit to generate the control driving signal for turn-ON and turn-OFF of the MOS transistors in the even battery group.

7. A modularization method for battery equalizers based on multi-winding transformers, wherein the PWM signal output terminals of a microcontroller send a pair of complementary PWM signals to respectively control the alternate turn-ON of the MOS transistors for the odd and the even multi-winding transformers, the balancing in battery modules and between the odd and the even groups is realized based on forward conversion, and the balancing between the odd and the even groups and the automatic demagnetization for the transformers are realized based on flyback conversion.

8. The modularization method for battery equalizers based on multi-winding transformers according to claim 7, wherein the control method comprises four operation modes:
(1) when the MOS transistors of the odd transformers are turned ON, the demagnetization of the even transformers are automatically realized based on flyback conversion, the balancing between the odd and the even groups is realized, and the balancing in the odd groups and between the battery modules is realized based on forward conversion;
(2) the MOS transistors of the odd transformers remain ON, the balancing in the odd groups and between the battery modules is realized based on forward conversion, and a precondition is provided for demagnetization of the odd transformers;
(3) the MOS transistors of the even transformers are turned ON, the demagnetization of the odd transformers are automatically realized based on flyback conversion, the balancing between the odd and the even groups is realized, and the balancing in the even groups and between the battery modules is realized based on forward conversion; and
(4) the MOS transistors of the even transformers remain ON, and the balancing in the even groups and between the battery modules is still realized based on forward conversion.

9. The modularization method for battery equalizers based on multi-winding transformers according to claim 8, wherein after the continual alternation of the four modes, the balancing in the battery modules and between the odd and the even groups is realized based on forward conversion; and the balancing between the odd and the even groups is realized based on flyback conversion, thereby achieving the global balancing of the whole battery strings, and automatically demagnetizing all the transformers.

10. The modularization method for battery equalizers based on multi-winding transformers according to claim 7, wherein the control method is applied to the charging, discharging or stationary state of the battery strings.
